(19) United States
(12) Patent Application Publication
(10) Pub. No.: US 2024/0119480 A1
(43) Pub. Date: Apr. 11, 2024

(54) SYSTEMS AND METHODS FOR ELECTRONIC LOYALTY-BASED TRANSACTIONS OVER ELECTRONIC MONETARY EXCHANGE NETWORKS

(71) Applicant: FIDELITY INFORMATION SERVICES, LLC, Jacksonville, FL (US)

(72) Inventors: Robert D. WOODBURY, Flemington, NJ (US); Deborah A. TESSLER, Jacksonville, FL (US)

(73) Assignee: FIDELITY INFORMATION SERVICES, LLC, Jacksonville, FL (US)

(21) Appl. No.: 18/390,165

(22) Filed: Dec. 20, 2023

Related U.S. Application Data
(63) Continuation of application No. 16/825,899, filed on Mar. 20, 2020.
Application No. 16/825,899 is a continuation of application No. 16/448,599, filed on Jun. 21, 2019, now abandoned.
(60) Provisional application No. 62/689,747, filed on Jun. 25, 2018.

(51) Int. Cl. G06Q 30/0226; G06Q 20/38; G06Q 20/40; G06Q 20/42

(52) U.S. Cl. CPC G06Q 30/0233; G06Q 20/385; G06Q 20/4014; G06Q 20/4015; G06Q 20/405; G06Q 20/42

(57) ABSTRACT

Computer-implemented systems and methods for initiating a transaction, the transaction generating a validation request to verify a customer's identity, the validation request requesting a first unique randomized identifier from a mobile payment cloud; transmitting the first unique randomized identifier to a customer device, the first unique randomized identifier being forwarded to the mobile payment cloud as a second unique randomized identifier to validate the transaction; receiving an authentication from the mobile payment cloud based on a result of validating the transaction; transmitting a customer identification code and the cash value to an interbank network as an interbank transaction request; receiving a response from the interbank network regarding the interbank transaction request; and processing the transaction based on the response from the interbank network.

### TECHNICAL FIELD

The present disclosure generally relates to computerized methods and systems for processing a point-based payment transaction using a payment network and more particularly to methods and system for processing cash withdrawals and point of sale transactions based on accumulated points associated with loyalty program accounts.

### BACKGROUND

Traditional payment networks are configured to process and enable financial transactions between various financial entities and merchants through the transfer of cash having a particular cash value. The transfer of cash or traditional cash-substitutes may be accomplished using negotiable instruments and/or electronic payment means including debit cards, credit cards, electronic fund transfers, etc. Each transfer thereof may be subject to procedures and protocols of a payment network based on one or more transaction rules associated with the payment network.

With the advent of alternative payment means, financial entities have developed non-traditional cash substitutes for use in financial transactions. For example, many financial service providers, including banks, credit card companies, and retailers offer one or more loyalty programs, by which a consumer can earn “points,” “tokens,” “miles,” or other alternative non-cash items, for example, as a reward for completing a transaction with a participating entity (a financial entity or a merchant). For example, a financial service provider may offer points as a reward to consumers enrolled in a loyalty program as an incentive to complete a transaction with a participating entity. However, the participating entity must enroll with the financial service provider prior to allowing consumers to earn points as part of the loyalty program.

Despite the ubiquitous nature of earning points as part of a loyalty program, consumers face limited options for redeeming the earned points. For example, the availability of participating entities allowing points to be redeemed as a cash substitute may be limited, due in part to difficulties associated with validating a point-based payment transaction through verifiable payment networks and a lack of standardized protocols for point redemption. Thus, point redemption as a cash substitute has traditionally been limited to transactions pre-authorized by an entity participating in a redemption aspect of a loyalty program. Moreover, participating entities may require particularized hardware, such as a near-field communication (NFC) reader, for enabling communication between transaction terminals and loyalty program management platforms. Thus, a situation arises where a consumer can earn points when transacting with a participating entity but is unable to redeem the earned points as a cash substitute at the same participating entity location. This invariably limits consumer options for completing a transaction by forcing a consumer to choose between paying with cash or traditional electronic payment means at a nonparticipating entity location, or completing the transaction using points at one of the limited participating entity locations.

Difficulties associated with validating a point-based payment transaction through verifiable payment networks have been complicated by the limited transferability of points associated with a loyalty program specific to a particular financial service provider. Implementing a standardized protocol for processing non-traditional financial transactions, such as points earned as part of a loyalty program, have been complicated by a limited number of network participants authorizing the use of points as a form of currency and the variability of earning to redemption ratios between various participating entities.

These and other technological problems have complicated advances to streamline point redemption. Moreover, existing payment networks do not enable processing a point-based payment transaction for redemption of cash (i.e. ATM withdrawals).

Therefore, a need exists in the financial service industry to enable a transaction to be processed using points associated with a loyalty program as a cash or traditional electronic payment substitute using a standardized set of rules and without disrupting existing payment networks. The present disclosure is directed to addressing these and other challenges.

### SUMMARY

One aspect of the present disclosure is directed to a computer-implemented system. The system comprises a non-transitory computer-readable medium configured to store instructions and at least one processor configured to execute the instructions to perform operations. The operations comprise: initiating a transaction, the transaction generating a validation request to verify a customer's identity, the validation request requesting a first unique randomized identifier from a mobile payment cloud; transmitting the first unique randomized identifier to a customer device, the first unique randomized identifier being forwarded to the mobile payment cloud as a second unique randomized identifier to validate the transaction; receiving an authentication from the mobile payment cloud based on a result of validating the transaction; transmitting a customer identification code and the cash value to an interbank network as an interbank transaction request; receiving a response from the interbank network regarding the interbank transaction request; and processing the transaction based on the response from the interbank network.

Yet another aspect of the present disclosure is directed to another computer-implemented system. The system comprises a non-transitory computer-readable medium configured to store instructions and at least one processor configured to execute the instructions to perform operations. The operations comprise: receiving, from a financial transaction system, a transaction request, the transaction request comprising one or more customer identification codes and transaction information; determining one or more loyalty account numbers from the customer identification codes; receiving, from one or more financial service providers, at least one point balance of at least one loyalty account associated with the loyalty account numbers; determining one or more transaction rules; determining, based on the transaction rules, a point equivalence corresponding to the cash value of the transaction request; and generating a response to the transaction request, wherein the generated response is based on a comparison of the point balance and the point equivalence.

Yet another aspect of the present disclosure is directed to another computer-implemented system. The system comprises a non-transitory computer-readable medium configured to store instructions and at least one processor configured to execute the instructions to perform operations. The operations comprise: receiving a customer-specific information from a customer; creating one or more virtual accounts for the customer based on the customer-specific information; receiving loyalty account information of one or more loyalty cards; requesting validation of the loyalty account information against a record in a database of a financial service provider; receiving one or more customer identification codes in response to a positive validation of the loyalty account information; removing the loyalty account information; receiving a point balance of at least one loyalty account and a set of transaction rules based on the customer identification codes; determining a first cash equivalent of the point balance for a cash withdrawal transaction based on the set of transaction rules; determining a second cash equivalent of the point balance for a point of sale transaction based on the set of transaction rules; and displaying the point balance, the first cash equivalent, the second cash equivalent on a display of a customer device.

Other aspects of the present disclosure are directed to computer-implemented methods for performing the functions of the computer-implemented systems discussed above.

Other systems, methods, and computer-readable media are also discussed herein.

### BRIEF DESCRIPTION OF THE DRAWINGS

FIG. 1 is a schematic diagram of an exemplary system for processing a point-based payment transaction, consistent with the disclosed embodiments.

FIG. 2 is a block diagram of a server computer system, such as those depicted in FIG. 1, consistent with the disclosed embodiments.

FIG. 3 is a flowchart of an exemplary front-end process for processing a transaction request using a customer device, financial transaction system, and a payment cloud network, consistent with the disclosed embodiments.

FIG. 4 is a flowchart of an exemplary back-end process for processing a transaction request received from a front-end process such as the one depicted in FIG. 4, consistent with the disclosed embodiments.

### DETAILED DESCRIPTION

The disclosed embodiments include systems and methods for processing point-based payment transactions. For illustrative purposes only, the following description assumes the points are associated with a loyalty program. However, it is contemplated that the points can be represented by any type of alternative tender as a medium of exchange, such as digital currency (e.g., cryptocurrency), commodity money, etc. Moreover, it will be appreciated by those skilled in the art that the principles and embodiments of the present disclosure can be readily applied to the processing of point-based payment transactions in other technical areas.

Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present exemplary embodiments of the disclosure, examples of which are illustrated in the accompanying drawings. Wherever possible, the same reference numbers will be used throughout the drawings to refer to the same or like parts.

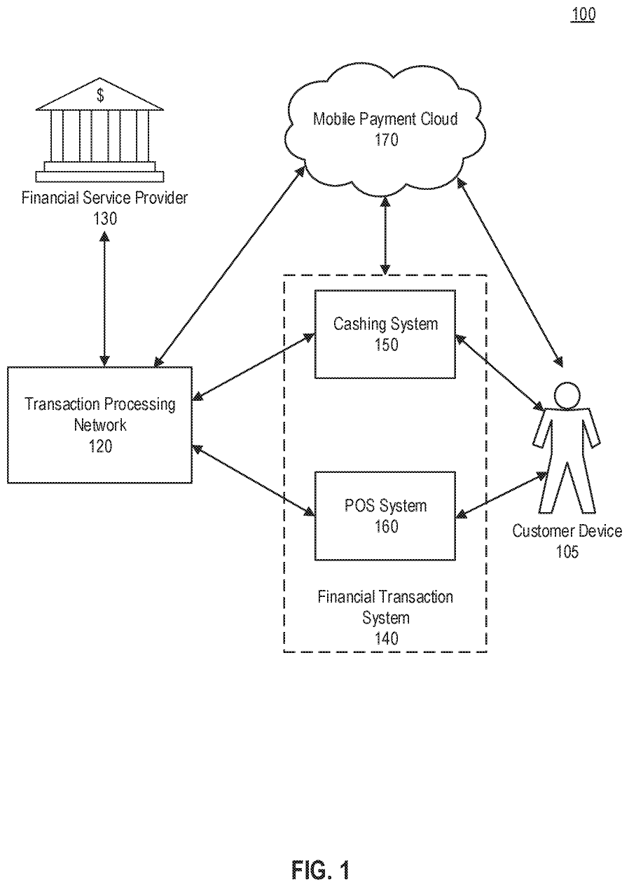

FIG. 1 is a schematic diagram illustrating a system 100 for processing a point-based payment transaction, consistent with the disclosed embodiments. As shown in FIG. 1, system 100 includes, transaction processing network 120, financial service provider 130, financial transaction system 140, and mobile payment cloud 170.

Transaction processing network 120 may be one or more computer systems associated with one or more financial entities, such as a financial service provider 130. Transaction processing network 120 may be an Interbank Network (such as NYCE®, INTERAC®, or the like). Interbank Networks allow money systems (such as ATMs or payment terminals) to access deposit or other accounts. In some embodiments, transaction processing network 120 may enable the use of ATM cards issued by a bank to be used at a point of sale through an EFTPOS (Electronic Fund Transfer at Point Of Sale) system. Rather than operating as a credit card transaction, which would typically need to go through a credit card issuer system, an EFTPOS transaction could be received by transaction processing network 120 and routed to the appropriate bank holding the account.

In some embodiments, transaction processing network 120 may also provide a loyalty program to customer device 105 for earning and redeeming points through transactions with one or more financial service providers 130 or financial transaction systems 140, such as a cashing system 150 (e.g., ATM), and a POS system 160. Consistent with the present disclosure, transaction processing network 120 receives one or more requests for processing transactions initiated by customer device 105 or financial transaction system 140. In the disclosed embodiments, transaction processing network 120 may be developed and operated by a third-party service provider authorized by financial service provider 130 to process payment transactions. In other embodiments, Transaction processing network 120 may be associated with one or more financial service providers 130 for processing financial transactions.

Transaction processing network 120 may include one or more components that perform processes consistent with the disclosed embodiments. For example, transaction processing network 120 may include one or more computers (e.g., servers, database systems, etc.) that execute software instructions programmed to perform aspects of the disclosed embodiments, such as managing a loyalty program, collecting data regarding transaction requests, processing transaction requests according to one or more transaction rules, transmitting an authorization response, and settling a completed payment transaction.

Transaction processing network 120 may provide a connectivity infrastructure for enabling communication among the various entities and financial transaction systems 140, processing transactions and/or payment transfers. Transaction processing network 120 may be implemented as part of or in conjunction with a Local Area Network (LAN) or, a Wide Area Network (WAN) (such as the internet) and may be a single network or a combination of networks. Further, transaction processing network 120 may be implemented as a single type of network or a combination of different types of networks (e.g., networks for wireline and/or wireless communications). Transaction processing network 120 may also utilize cloud computing technologies (e.g., for storage, caching, or the like). Transaction processing network 120 can be national, international, or both. Transaction processing network 120 is not limited to the above examples and system 100 may implement any type of network that allows the entities (shown and not shown) included in FIG. 1 to exchange data and information.

Financial service provider 130 may be an entity that provides financial services. For example, financial service provider 130 may be a bank, a check clearing house, or other type of financial service entity that configures, offers, provides, and/or manages financial service accounts, such as checking accounts, savings accounts, debit card accounts, loyalty accounts, etc. These financial service accounts may be used with customer device 105 to purchase goods and/or services. Financial service provider 130 may participate in a loyalty program provided by transaction processing network 120, which may perform one or more aspects of the disclosed embodiments.

Financial transaction system 140 may include one or more of cashing system 150 or POS (point of sale) system 160. Cashing system 150 may be implemented as a computer or other electronic device operable to receive a cash withdrawal transaction request from a customer device 105. In some embodiments, cashing system 150 may be implemented as an automated teller machine (ATM) configured to receive data associated with a customer loyalty account. In other embodiments, cashing system 150 may be implemented at one or more retail locations. Transaction processing network 120 associated with cashing system 150 may receive a loyalty account number or an alias of the loyalty account number from customer device 105 to determine a loyalty account and transmit the cash withdrawal transaction request to transaction processing network 120. The processor associated with cashing system 150 may also receive a cash withdrawal transaction request from customer device 105 through an application program interface (API). Cashing system 150 may be configured to receive instructions from transaction processing network 120 for dispensing cash to customer device 105.

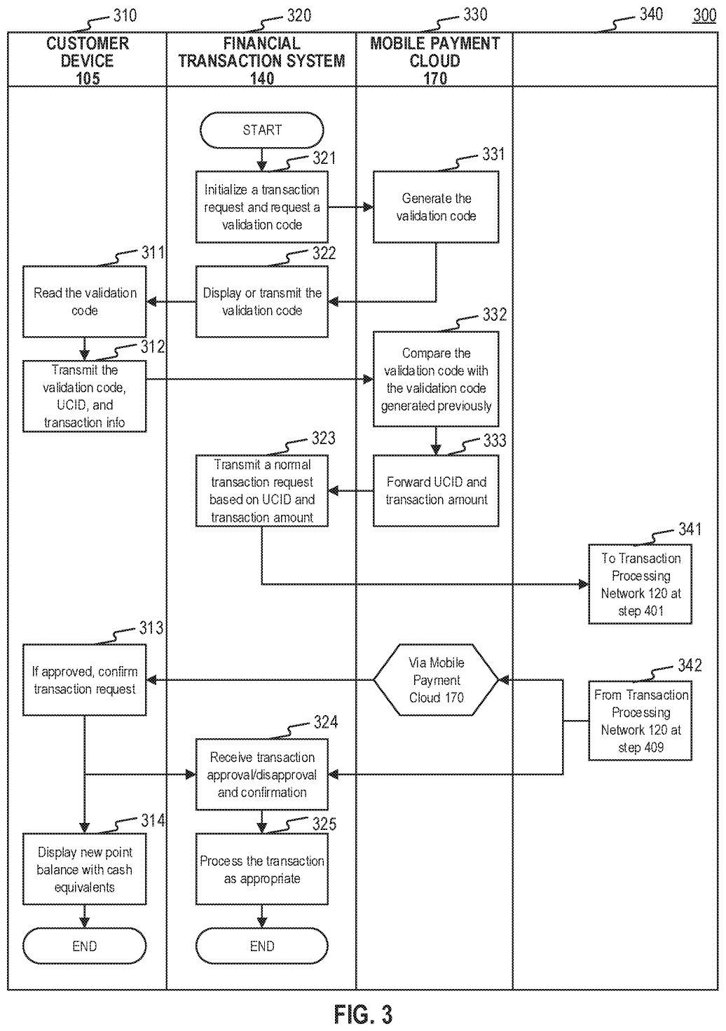

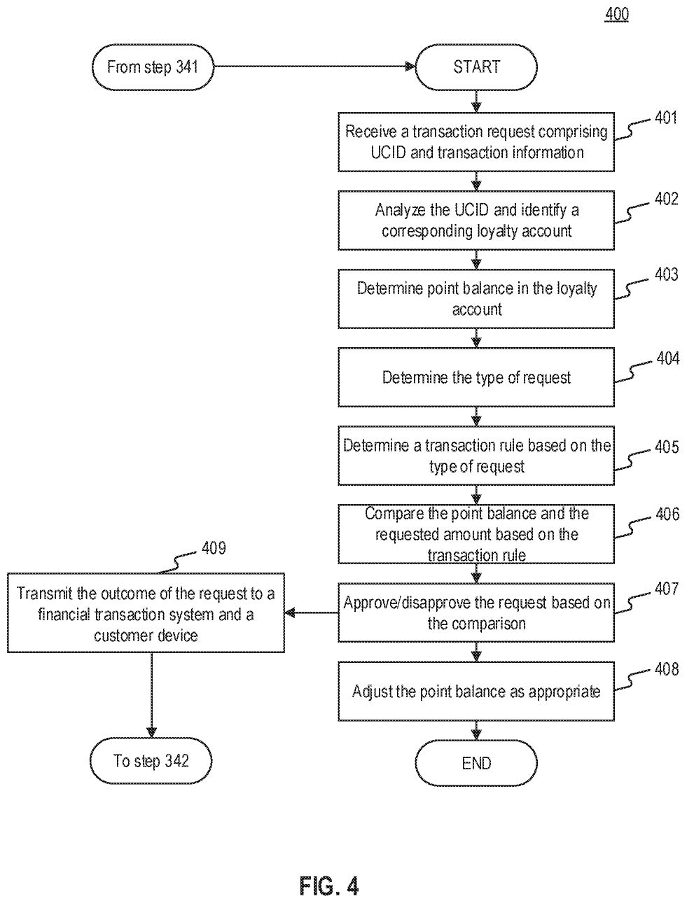

POS system 160 may be a computer system or other electronic device operable to transmit a POS transaction request for completing a payment transaction using a cash substitute. The POS transaction request may include an indication to apply points associated with a loyalty program towards payment of a pending transaction at a point of sale location. In an example, POS system 160 may receive a loyalty account identifier (e.g., number, alphanumeric code, visual indicator, etc.) from customer device 105 to determine a loyalty account and transmit the POS transaction request to transaction processing network 120 for identifying a loyalty account associated with customer device 105. POS system 160 may thereafter receive an indication from transaction processing network 120 that a payment is authorized. In some embodiments, POS system 160 may also be operable to split the monetary amount of the POS transaction request into more than one portion and create a corresponding number of POS transaction requests for completing the payment transaction using any combination of cash or one or more cash substitutes. In this case, each of the one or more cash substitutes may be associated with a corresponding loyalty account. This allows a customer to utilize more than one mode of payment to pay for goods or services. In this case, POS system 160 may split the monetary amount and generate a corresponding number of POS transaction requests with the portions of the monetary amount. POS system 160 may then process each of the POS transaction requests as described below with respect to FIGS. 3 and 4.

In other embodiments, POS system 160 may be implemented as an attended machine (e.g., by a cashier or clerk) or an automated kiosk (e.g., by customer 105 actuating a screen or buttons on an unmanned or cashier-less kiosks) operable to transmit a request for processing payment of the transaction to transaction processing network 120. In other embodiments, POS system 160 may be implemented as a personal computer, online terminal, or mobile device operating a software application configured to generate a transaction request and transmit the POS transaction request to transaction processing network 120. In other embodiments, POS system 160 may be a retail point-of-sale device, e-commerce website, or mobile application configured to receive checking account information.

Mobile payment cloud 170 may provide a connectivity infrastructure for enabling communication among financial service provider 130 via transaction processing network 120, financial transaction system 140, and customer device 105. Mobile payment cloud 170 may be implemented using a wireless network, a cellular network, a satellite network, or the like. Mobile payment cloud 170 may serve, for example, as a second communication channel, separate from the communication between transaction processing network 120 and financial transaction system 140, for verifying information during an initial registration process or during each transaction request to prevent fraudulent activity, in a manner consistent with the disclosed embodiments. In some embodiments, mobile payment cloud 170 may work in conjunction with customer device 105 to verify information using known techniques such as multi-factor authentication, biometric authentication, or the like.

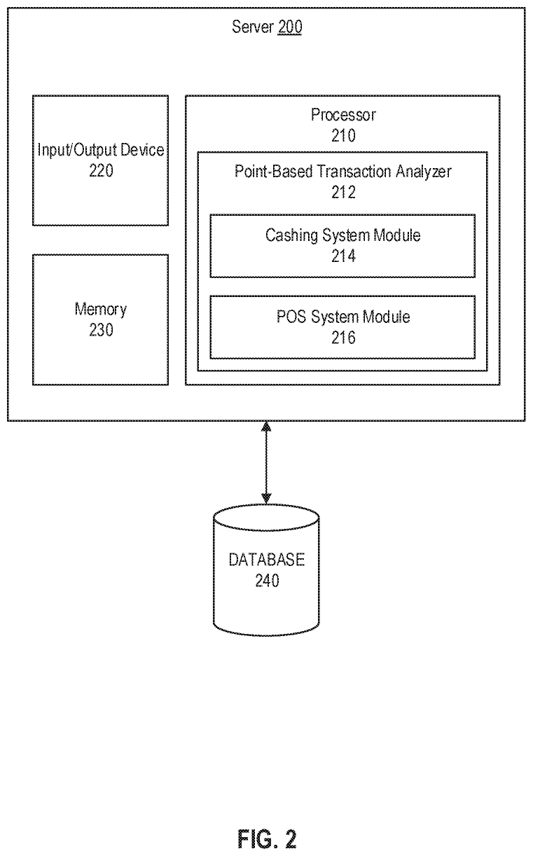

FIG. 2 depicts a server 200, consistent with disclosed embodiments. In an exemplary embodiment, transaction processing network 120 includes one or more server 200 machines. Server 200 may be one or more computing devices configured to execute software instructions stored in memory to perform one or more processes consistent with the disclosed embodiments. For example, server 200 may include one or more memory devices for storing data and software instructions and one or more hardware processors to analyze the data and execute the software instructions to perform server-based functions and operations. Server 200 may be configured to execute stored software instructions to process various transactions using accumulated value associated with a loyalty account of customer device 105, in a manner consistent with the disclosed embodiments.

In one embodiment, server 200 may include one or more hardware processors 210, one or more input/output (I/O) devices 220, and one or more memories 230. Server 200 may be standalone, or it may be part of a subsystem, which may be part of a larger system. For example, server 200 may represent distributed servers that are remotely located and communicate over a network.

Processor 210 may include or one or more known processing devices such as, for example, a microprocessor. In some embodiments, processor 210 may include any type of single or multi-core processor, mobile device microcontroller, central processing unit, etc. In operation, processor 210 may execute computer instructions (program code) and may perform functions in accordance with techniques described herein. Computer instructions may include routines, programs, objects, components, data structures, procedures, modules, and functions, which may perform particular processes described herein. In some embodiments, such instructions may be stored in memory 230, in processor 210, or elsewhere. Consistent with the disclosed embodiments, processor 210 may include point-based transaction analyzer 212 configured to receive a transaction request and orchestrate one of cashing system module 214 or POS system module 216 for processing the transaction request. In other embodiments, cashing system module 214 and/or a POS system module 216 may be organized or arranged separately from point-based transaction analyzer 212. In further embodiments, cashing system module 214 and POS system module 216 may be combined into one module serving the functions of both modules.

I/O device 220 may be one or more devices configured to allow data to be received and/or transmitted by server 200. I/O device 220 may include one or more customer I/O devices and/or components, such as those associated with a keyboard, mouse, touchscreen, display, etc. I/O device 220 may also include one or more digital and/or analog communication devices that allow server 200 to communicate with other machines and devices, such as other components of system 100. I/O device 220 may also include interface hardware configured to receive input information and/or display or otherwise provide output information. For example, I/O device 220 may include a monitor configured to display a customer interface.

Memory 230 may include one or more storage devices configured to store instructions used by processor 210 to perform functions related to disclosed embodiments. For example, memory 230 may be configured with one or more software instructions associated with programs and/or data.

Memory 230 may include a single program that performs the functions of the server 200, or multiple programs. Additionally, processor 210 may execute one or more programs located remotely from server 200. Memory 230 may also store data that may reflect any type of information in any format that the system may use to perform operations consistent with disclosed embodiments. Memory 230 may be a volatile or non-volatile (e.g., ROM, RAM, PROM, EPROM, EEPROM, flash memory, etc.), magnetic, semiconductor, tape, optical, removable, non-removable, or other type of storage device or tangible (i.e., non-transitory) computer-readable medium.

Server 200 may also be communicatively connected to one or more databases 240. For example, server 200 may be communicatively connected to database 240 through transaction processing network 120. Database 240 may include one or more memory devices that store information and are accessed and/or managed through server 200. By way of example, database 240 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 200 may include database 240. Alternatively, database 240 may be located remotely from the server 200. Database 240 may include computing components (e.g., database management system, database server, etc.) configured to receive and process requests for data stored in memory devices of database 240 and to provide data from database 240.

In an example, point-based transaction analyzer 212 may include instructions to call an API for integrating a loyalty account with transaction processing network 120. The services related to the API may, via a mobile device application, prompt a customer to input customer-specific information on customer device 105. The customer-specific information may include one or more of a first name, last name, phone number, email address, and/or a temporary verification code. The API may, via mobile payment cloud 170 and transaction processing network 120, communicate with financial service provider 130 to verify the customer-specific information against a database of account holders at financial service provider 130. When a match is found, the API may use the customer-specific information to generate a virtual account profile that a customer can use to access account information on customer device 105. The virtual account profile may be stored on customer device 105 as a mobile application, a digital wallet card, or the like.

Once the virtual account profile is created, the API may, via the mobile device application, prompt the customer to input account-specific information, specific to a loyalty account, on customer device 105. The account-specific information may include one or more of a loyalty card number, a card verification value (CVV), and a zip code of the customer's address. The API may, via mobile payment cloud 170 and transaction processing network 120, communicate with financial service provider 130 again to verify the account-specific information against a database of loyalty accounts at financial service provider 130. When a matching loyalty account is identified, point-based transaction analyzer 212 may generate a substitute value corresponding to a loyalty account number associated with the identified loyalty account and transmit the substitute value to customer device 105. Point-based transaction analyzer 212 may generate the substitute value using any suitable method known in the art such as tokenization.

For example, point-based transaction analyzer 212 may comprise a tokenization system that generates a token or a reference as the substitute value that maps back to the loyalty account number. The token may be a series of random characters in any form, for example, alphanumeric, alphabetic, numeric, text, hash-based, or binary. The mapping between the token and the loyalty account number may be protected information that resides only in the tokenization system, and the randomness of the token may ensure that a token cannot be reverse engineered by a third-party to uncover the loyalty account number.

In some embodiments, the substitute value may be generated such that financial transaction system 140 recognizes it as associated with a particular transaction processing network 120 or a particular financial service provider 130. As one example, the substitute value may be in the form of a constructed value. A constructed value, in some embodiments, comprises a string of numbers formatted to resemble a traditional card number. For example, such a constructed value may contain a particular value as part of the BIN (Bank Identification Number) or the IIN (Issuer Identification Number), such as ‘777,’ which indicates that the constructed value is associated with a particular financial service provider 130. Although the constructed value may not correspond to a particular account, the constructed value's attribute of resembling a payment card number may facilitate routing a transaction that includes the constructed value via transaction processing network 120, as though it were a traditional card-based transaction, so that the front-end process 300 can be performed on a wide variety of financial transaction systems 140 even when a particular cashing machine 150 or a POS system 160 may not be participating in a loyalty program by a particular financial service provider 130.

Once the substitute value is received, the API may associate the substitute value with the virtual account profile, assigning the substitute value as a unique customer identification code (UCID). The loyalty account identifier may provide an indication that value or points associated with loyalty account balance shall be used as funding or value for processing and completing a transaction request. The API may then remove the account-specific information from customer device 105 using methods known in the art for deleting sensitive data from memory. Subsequent transaction requests may include UCID as a means to authenticate the transaction requests, where transaction processing network 120 may analyze UCID to identify a loyalty account associated with UCID. This minimizes the risk of exposure or security concerns for the customer by limiting the use of actual loyalty account number to the initial account registration.

In some embodiments, customer device 105 may also receive a current point balance in the registered loyalty account along with one or more transaction rules for determining a cash equivalent of the point balance for different transaction types. For example, customer device 105 may receive two transaction rules, one from cashing system module 214 for determining a cash equivalent for a cash withdrawal transaction request, and the other from POS system module 216 for determining a cash equivalent for a POS transaction request. In other embodiments where cashing system module 214 and POS system module 216 are combined into one module, customer device 105 may receive the transaction rules from the combined module. In some embodiments, customer device 105 may display one or more of the point balance, the cash equivalent for a cash withdrawal, and the cash equivalent for a POS transaction.

On the other hand, when no match can be found, either for the customer-specific information or the account-specific information, or when a customer's loyalty account is ineligible to be registered to customer device 105 as described above, point-based transaction analyzer 212 may return an error message to customer device 105, notifying the customer of the outcome. The determination of whether a loyalty account is eligible may be based on whether financial service provider 130 for the loyalty account supports allows such registration.

FIG. 3 illustrates a flowchart of an exemplary front-end process 300 for processing one or more transaction requests using points associated with a loyalty program, consistent with the disclosed embodiments. For example, front-end process 300 may involve actions by customer device 105, financial transaction system 140 such as cashing system 150 or POS system 160, and mobile payment cloud 170. Referring to FIG. 3, actions that may be performed by each element are organized into columns 310, 320, and 330, respectively.

At step 321, financial transaction system 140 may initiate a transaction request, where the transaction request includes information about the nature of the transaction such as the transaction type, cash value of the transaction amount, location of the transaction, identity of the requesting entity, and a request for a validation code.

For example, when cashing system 150 is serving as financial transaction system 140, cashing system 150 may initialize a transaction request based on a customer input for withdrawing cash from the customer's loyalty account via cashing system 150. In some embodiments, cashing system 150 may receive the customer input through an input device on cashing system 150 such as a touchscreen display, a non-touchscreen display, a keyboard, a pointing device, buttons, or other input device. In other embodiments, cashing system 150 may receive the customer input from customer device 105, where the customer prearranged for a cash withdrawal from their loyalty account using a mobile application and a virtual account profile registered in the manner disclosed above.

In another example, when POS system 160 is serving as financial transaction system 140, POS system 160 may initialize a transaction request based on an input from a cashier or a clerk for a sale of goods or services or based on an input from a customer using an automated kiosk. Alternatively, the transaction request may be for a return or a refund and the cash value of the transaction amount may be a negative value. In some embodiments, the input may be from an input device on POS system 160 such as a touchscreen display, a non-touchscreen display, a keyboard, a pointing device, buttons, or other input device.

At step 331, mobile payment cloud 170 generates a validation code based on the transaction request and transmits the generated validation code back to financial transaction system 140. The validation code may take any form, for example, alphanumeric, alphabetic, numeric, text, has-based, or binary. Mobile payment cloud 170 may generate the validation code using any suitable method known in the art such as tokenization. Mobile payment cloud 170 may also store the generated validation code for verification later in front-end process 300.

At step 322, financial transaction system 140 may generate an image where the validation code is encoded in a scannable format such as a barcode or a Quick Response (QR) code. A customer may then scan the image using customer device 105, thereby receiving the validation code without revealing the actual code. In some embodiments, financial transaction system 140 may additionally or alternatively transmit the validation code to customer device 105 via an NFC protocol or a similar short-range wireless communication protocol.

At step 311, customer device 105 may scan the image displayed on financial transaction system 140 as disclosed above and analyze the scanned image to determine the validation code. In other embodiments, customer device 105 may receive the validation code directly via a wireless communication protocol without having to encode and decode the validation code in an image.

At step 312, customer device 105 may transmit the validation code, loyalty account information, and transaction information to mobile payment cloud 170 for verification. In some embodiments, the loyalty account information may include the UCID generated during the initial registration process disclosed above. Also in some embodiments, the transaction information may include the cash value of the transaction amount and/or location of the transaction.

At step 332, mobile payment cloud 170 may compare the validation code and the transaction information received from customer device 105 with the validation code and the transaction request stored at step 331 above. Matching data may indicate that the transaction request has passed a verification process and that the transaction is ready to be processed. Thus, at step 333, mobile payment cloud 170 may forward the loyalty account information and the cash value of the transaction amount to financial transaction system 140. On the other hand, a mismatch may indicate that there may be something wrong with the transaction request, causing mobile payment cloud 170 to generate a message for customer device 105 and financial transaction system 140. In some embodiments, the message may inform users of customer device 105 (i.e., the customer) and/or financial transaction system 140 (e.g., ATM, cashier, or clerk) of the mismatch and terminate the transaction request.

At step 323, financial transaction system 140 transmits a transaction request to transaction processing network 120 based on the loyalty account information and the cash value of the transaction amount. The transmitted transaction request is no different from traditional transaction requests for withdrawing cash or paying for goods or services with cash instead of points. This allows a customer to use any financial transaction system, regardless of whether it is operated by an entity participating in the loyalty program associated with the loyalty account of the customer or not, to access points stored in the loyalty account. The transaction request may further include other information such as a name of the entity making the transaction request (e.g., store name), description of the item or service being purchased, a geographical location where the transaction is made, and date.

In some embodiments, financial transaction system 140 may add a surcharge to the cash value of the transaction amount, thereby allowing a customer to fund the entire transaction using points. For example, when a customer wishes to withdraw $100 using cashing system 150 that is not affiliated with their loyalty program, financial transaction system 140 may transmit a transaction request for $102 to account for a surcharge of $2.

Between steps 341 and 342, the transmitted transaction request is processed by transaction processing network 120 and a determination as to its approval or rejection is transmitted back. The series of steps (back-end process 400) that occur between steps 341 and 342 is described below with respect to FIG. 4.

When the transaction request is approved, customer device 105, at step 313, prompts the customer to confirm the transaction via the mobile application. In some embodiments, customer device 105 may also display the current point balance in the customer's loyalty account, the cash value of the transaction amount including any surcharge, and/or the point equivalent of the transaction amount. The customer may confirm the transaction through an input device of customer device 105 such as a touchscreen display, buttons, a biometric authenticator, or the like. Next, at step 314, customer device 105 may display the new point balance in the customer's loyalty account after the transaction is completed, as well as cash equivalents of the point balance for cash withdrawal transactions and POS transactions.

Furthermore, when the transaction request is approved, financial transaction system 140 may receive the approval from transaction processing network 120 and a confirmation by customer device 105 at step 324. Financial transaction system 140 may then process the transaction as appropriate, at step 325, dispensing cash when the transaction request was a cash withdrawal transaction, for example, and providing goods or services when the transaction request was a POS transaction request.

Alternatively, when the transaction request is rejected, customer device 105 may display a message to the customer informing them of the rejection. In some embodiments, customer device 105 may also display a confirmation indicating that the point balance did not change as a result of the rejection. Furthermore, financial transaction system 140 may void the transaction, transmitting a signal to customer device 105 that confirms the rejected transaction request from transaction processing network 120 and indicating any surcharge or penalty that may be charged to the loyalty account based on a pre-existing contractual arrangement between the customer and financial service provider 130.

In this case, financial transaction system 140 may transmit a follow-up transaction request to transaction processing network 120 based on the corresponding UCID and a predetermined surcharge or penalty amount, which may be processed by transaction processing network 120 as a usual transaction request as described above with respect to FIG. 4. If no surcharge or penalty is required, no further action is necessary between financial transaction system 140 and transaction processing network 120, because transaction processing network 120 would not have deducted any points from the loyalty account based on the determination that the transaction request should be rejected.

FIG. 4 is a flowchart of an exemplary back-end process 400 for processing a transaction request received from a front-end process such as the one described above with respect to FIG. 3, consistent with the disclosed embodiments. For example, back-end process 400 may be performed by transaction processing network 120, or more specifically, point-based transaction analyzer 212.

At step 401, point-based transaction analyzer 212 may receive a transaction request transmitted by financial transaction system 140, for example, at step 323 of FIG. 3. The transaction request may comprise UCID associated with a customer's loyalty account and a cash value of the transaction amount. In some embodiments, the cash value of the transaction amount may include a surcharge as disclosed above with respect to step 323. Alternatively, or additionally, point-based transaction analyzer 212 may receive the transaction request from the API called to integrate the loyalty account with transaction processing network 120. Customer device 105 may input data into a mobile application in communication with the API for transmitting the transaction request. The input data may include a geographical location of a cashing system 150 or a POS system 160 for completing the transaction.

At step 402, point-based transaction analyzer 212 may analyze the received UCID to identify a corresponding loyalty account that the received UCID substituted for as described above with respect to the initial account registration. Identifying the corresponding loyalty account may involve any suitable method known in the art such as detokenization. For example, detokenization may involve using one or more secure keys to decrypt UCID into its actual loyalty account number, where the one or more secure keys were originally used during initial account registration to generate UCID. In some embodiments, point-based transaction analyzer 212 may be the only means available to decode UCID into its corresponding loyalty account for security purposes.

At step 403, point-based transaction analyzer 212 may determine an available point balance associated with the identified loyalty account by querying financial service provider 130 providing the corresponding loyalty program.

At step 404, point-based transaction analyzer 212 may determine a request type for the transaction request, which may include, but is not limited to, a cash withdrawal transaction request or a POS transaction request. A POS transaction request may be a debit request or a refund request. The determination of the type of request may be based on the analysis in step 401. For example, point-based transaction analyzer 212 may analyze the transaction request received at step 401 to identify one or more characteristics of the transaction request. In one embodiment, the transaction request may conform to a programming structure and/or include a processing code that enables point-based transaction analyzer 212 to distinguish between a cash withdrawal transaction request and a POS transaction request (or between any other request type(s)). Point-based transaction analyzer 212 may determine that the transaction request is a cash withdrawal transaction request based on one or more indicators included in a customer input and/or information associated with a generated transaction. In other examples, point-based transaction analyzer 212 may identify a transaction request as a POS transaction request based on determining the transaction request is associated with a sale of goods and/or an electronic payment to a third-party account.

At step 405, point-based transaction analyzer 212 may determine an exchange rate transaction rule for use in processing the transaction request. The determination may be based on the determination of step 404 regarding the type of transaction request. Server 200 may include a predetermined set of rules associated with each type of request, wherein the predetermined set of rules includes an exchange rate for determining point equivalence corresponding to the cash value of the transaction request.

For example, the exchange rate transaction rule for a cash withdrawal request may use a higher rate of exchange than the exchange rate transaction rule for a POS transaction request, requiring a greater number of points for $1. The opposite may be true in another embodiment. Furthermore, the exchange rate transaction rule may have a variable rate of exchange where the number of points required for $1 increases or decreases based on a tiered structure. For example, every dollar between $0 and $100 may require 5 points per $1, while every dollar greater than $100 may require 3 points per $1. Still further, the exchange rate transaction rule may differ based on the entity requesting the exchange, where a merchant or a third-party network of ATM may negotiate a lower rate for exchange in order to attract more customers. It is also foreseeable that an exchange rate transaction rule may impose a penalty on certain types of transaction requests such as return or refund requests taking place after a predetermined period of time. Other exchange rules based on different circumstances surrounding a transaction request may be obvious to one of ordinary skill in the art.

In some embodiments, different parts of point-based transaction analyzer 212 may come into play based on the type of transaction. For example, cashing system module 214 may facilitate a conversion between points and cash values for cash withdrawal transaction requests, while POS system module 216 may facilitate the same for POS transaction requests. Point-based transaction analyzer 212 may also include other modules dedicated to other types of transaction requests.

At step 406, point-based transaction analyzer 212 may calculate a point equivalence for a cash value of a transaction request based on the determined exchange rate transaction rule. For example, in one embodiment, cashing system module 214 may determine, based on the determined exchange rate transaction rule associated with a cash withdrawal transaction request of step 405, that a cash value of $100 is equivalent to 10,000 points. In other embodiments, POS system module 216 may determine, based on a different exchange rate transaction rule associated with a POS transaction request, that a cash value of $100 at a point of sale location is equivalent to 7,400 points. Point-based transaction analyzer 212 may then compare the calculated point equivalence with the available point balance determined above at step 403.

Then at step 407, point-based transaction analyzer 212 may generate a response to the transaction request. The generated response may be based on a result of a comparison of the available point balance determined at step 403 and the point equivalence determined at step 406. For example, point-based transaction analyzer 212 may deny a transaction request where the available point balance is insufficient to cover the calculated point equivalence. Alternatively, point-based transaction analyzer 212 may approve the transaction request if the available point balance is equal to or greater than the point equivalence.

At step 408, point-based transaction analyzer 212 may transmit a signal to financial service provider 130 to deduct the available point balance in the loyalty account by the calculated point equivalence if the approved transaction request was a debit request such as a cash withdrawal request; or credit the loyalty account by the calculated point equivalence if the approved transaction request was a credit request such as a return or refund request.

In one embodiment, a predetermined transaction rule may enable point-based transaction analyzer 212 or its corresponding module to generate an authorization response. The generated response may be transmitted to financial transaction system 140 at step 409 via transaction processing network 120 and include instructions for authorizing the transaction request. For example, the generated response may authorize cashing system 150 to dispense cash equivalent to the cash value of the transaction request to customer device 105 or for authorizing POS system 160 to approve sale of an item.

Furthermore, the generated response may be transmitted to financial service provider 130 to adjust the point balance of the loyalty account based at least on the transaction type and the point equivalence for the cash value of the transaction request. In some embodiments, financial service provider 130 may transmit the new point balance to customer device 105 in order to keep the current balance information on customer device 105 up-to-date.

In some embodiments, the generated response may also include instructions for settling transactions between financial service provider 130 and financial transaction systems 140 at a predetermined interval, ensuring that financial transaction systems 140 receive cash values of the point-based transactions approved by point-based transaction analyzer 212 during the predetermined interval.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1.-40. (canceled)

41. A computer-implemented system, comprising:
a non-transitory computer-readable medium configured to store instructions; and
at least one processor configured to execute the instructions to perform operations comprising:
receiving a transaction request from a financial transaction system, wherein:
the transaction request includes a customer identifier and a transaction amount; and
the customer identifier is a substitute value for a customer loyalty account number, is formatted to resemble a payment card number, and is used to facilitate routing the transaction request via a transaction processing network;
analyzing the customer identifier to identify a loyalty account number associated with a customer;
determining a point balance in a loyalty account associated with the loyalty account number;
determining a transaction type based on information associated with the transaction request;
determining a loyalty point exchange rate based on the transaction type;
calculating a loyalty point equivalence for a cash value of the transaction amount based on the determined loyalty point exchange rate;
determining whether the loyalty account has sufficient points to complete the transaction, by comparing the calculated loyalty point equivalence with the determined point balance;
on a condition that the loyalty account has sufficient points to complete the transaction:
sending a transaction approval to the financial transaction system; and
updating a point balance in the loyalty account based on the calculated loyalty point equivalence.

42. The computer-implemented system of claim 41, wherein the transaction request is received from the financial transaction system via an application programming interface.

43. The computer-implemented system of claim 41, wherein analyzing the customer identifier includes detokenizing the customer identifier to identify the loyalty account number.

44. The computer-implemented system of claim 41, wherein:
the customer identifier is encrypted by the system when the customer identifier is created; and
analyzing the customer identifier further comprises decrypting the customer identifier to identify the loyalty account number.

45. The computer-implemented system of claim 41, wherein determining the point balance in the loyalty account includes querying a financial service provider to retrieve the point balance.

46. The computer-implemented system of claim 41, wherein the transaction type includes a cash withdrawal transaction request or a point of sale transaction request.

47. The computer-implemented system of claim 41, wherein the transaction request is formatted to conform to a programming structure and includes a processing code to determine the transaction type.

48. The computer-implemented system of claim 41, wherein the loyalty point exchange rate is dynamically determined based on one or more of: the transaction type, the transaction amount, or an entity requesting the transaction.

49. The computer-implemented system of claim 41, further comprising:
on a condition that the loyalty account has sufficient points to complete the transaction, sending an updated point balance in the loyalty account to a customer device.

50. The computer-implemented system of claim 41, further comprising:
on a condition that the loyalty account does not have sufficient points to complete the transaction, sending a message to a customer device indicating that the transaction request was denied.

51. A computer-implemented method performed by a transaction processing server, the method comprising:
receiving a transaction request from a financial transaction system, wherein:
the transaction request includes a customer identifier and a transaction amount; and
the customer identifier is a substitute value for a customer loyalty account number, is formatted to resemble a payment card number, and is used to facilitate routing the transaction request via a transaction processing network;
analyzing the customer identifier to identify a loyalty account number associated with a customer;
determining a point balance in a loyalty account associated with the loyalty account number;
determining a transaction type based information associated with the transaction request;
determining a loyalty point exchange rate based on the transaction type;
calculating a loyalty point equivalence for a cash value of the transaction amount based on the determined loyalty point exchange rate;
determining whether the loyalty account has sufficient points to complete the transaction, by comparing the calculated loyalty point equivalence with the determined point balance;
on a condition that the loyalty account has sufficient points to complete the transaction:
sending a transaction approval to the financial transaction system; and
updating a point balance in the loyalty account based on the calculated loyalty point equivalence.

52. The computer-implemented method of claim 51, wherein the transaction request is received from the financial transaction system via an application programming interface.

53. The computer-implemented method of claim 51, wherein analyzing the customer identifier includes detokenizing the customer identifier to identify the loyalty account number.

54. The computer-implemented method of claim 51, wherein:
the customer identifier is encrypted by the system when the customer identifier is created; and
analyzing the customer identifier further comprises decrypting the customer identifier to identify the loyalty account number.

55. The computer-implemented method of claim 51, wherein determining the point balance in the loyalty account includes querying a financial service provider to retrieve the point balance.

56. The computer-implemented method of claim 51, wherein the transaction type includes a cash withdrawal transaction request or a point of sale transaction request.

57. The computer-implemented method of claim 51, wherein the transaction request is formatted to conform to a programming structure and includes a processing code to determine the transaction type.

58. The computer-implemented method of claim 51, wherein the loyalty point exchange rate is dynamically determined based on one or more of: the transaction type, the transaction amount, or an entity requesting the transaction.

59. The computer-implemented method of claim 51, further comprising:
on a condition that the loyalty account has sufficient points to complete the transaction, sending an updated point balance in the loyalty account to a customer device.

60. The computer-implemented method of claim 51, further comprising:
on a condition that the loyalty account does not have sufficient points to complete the transaction, sending a message to a customer device indicating that the transaction request was denied.
